(19) United States
(12) Patent Application Publication
(10) Pub. No.: US 2014/0161299 A1
(43) Pub. Date: Jun. 12, 2014

(54) EAR TIP

(71) Applicant: Bill Yang, Taipei City (TW)

(72) Inventor: Bill Yang, Taipei City (TW)

(73) Assignee: Cotron Corporation, Taipei City (TW)

(21) Appl. No.: 13/772,370

(22) Filed: Feb. 21, 2013

(30) Foreign Application Priority Data
Dec. 7, 2012 (TW) 101146112

(51) Int. Cl. H04R 1/10

(52) U.S. Cl. CPC H04R 1/10
USPC 381/380

(57) ABSTRACT

An ear tip including an inner-tube portion, an outer-flange portion and a bump portion is provided. The inner-tube portion is configured to be mounted to an audio output tube of an insert-type earphone. The outer-flange portion is extended from a side of the inner-tube portion, surrounds the inner-tube portion, and has a smooth outer surface. The bump portion is disposed on the smooth outer surface, so as to maintain an air-leaking channel at periphery of the bump portion when the ear tip is inserting into a canal of a user.

### CROSS-REFERENCE TO RELATED APPLICATION

This application claims the priority benefit of Taiwan application serial no. 101146112, filed on Dec. 7, 2012. The entirety of the above-mentioned patent application is hereby incorporated by reference herein and made a part of this specification.

### BACKGROUND OF THE INVENTION

1. Field of the Invention

The present invention relates to an ear tip, and particularly relates to an ear tip for an insert-type earphone.

2. Description of Related Art

With the rapid progress in science and technology, all electronic products have been developed towards light, handy and miniaturized designs. People may use miniaturized electronic products, such as radios or walkmans, anytime and anywhere. Moreover, the personal digital product, such as common MP3 walkmans, cell phones, personal digital assistants (PDAs) or notebooks, has increasingly become popular, and thus being indispensable in the daily life. In addition, the cell phone integrated with functions of both radio and MP3 has immerged.

For each of those aforementioned electronic products, in order to allow a user to listen to the audio information provided by the electronic product without disturbing the other people around, an earphone has become a necessary accessory to the electronic product. Moreover, the earphone also provides a listener better audio transmission so that the listener can clearly hear and understand content of the audio information. In contrast to unclear audio transmission through the air, especially when the listener is moving, for example like doing exercises, driving, intensely moving around or being in a noisy environment, the audio transmission of the earphone still would not be affected.

Currently, the earphone which the audio output end thereof is miniaturized and mounted with an ear tip is a common one on the market. Accordingly, the audio output end may be inserted even deeper into a canal of a user and uses the elastic deformation of the ear tip to adopt different users' canal contours. This kind of earphone uses the ear tip to seal the canal of the user so as to shield external sound and enhance sound quality. However, due to the airtight property of the earphone, when the user plugs his canal with the earphone, the air between the user's eardrum and the earphone is compressed, which causes a heavy sense of pressure toward the eardrums and causes discomfort of the user. Meanwhile, the membrane inside the earphone is also deformed or even collapsed due to the air pressure, which damages the sound quality and significantly affects the comfort of hearing.

FIG. 1 is a schematic view of a conventional earphone inserted into a canal of a user. Referring to FIG. 1, U.S. Pat. No. 8,189,846 discloses an ear tip 54, mounted on an audio output tube 52 of the earphone 50. Meanwhile, a trench 56 is formed on an inner surface of the ear tip 54 so as to maintain an air-leaking path in the trench 56 after the ear tip 54 is mounted to the audio output tube 52. Thus, during the process of the ear tip 54 and the earphone 50 inserting into a canal of a user together, air is allowed to leak out from the trench 56, so as to avoid the discomfort of the eardrum. However, the size of the trench 56 is very small, and two ends 56A, 56B of the trench 56 are also very small, so the trench 56 is easily jammed by earwax or other particles such that the trench 56 cannot function normally.

### SUMMARY OF THE INVENTION

The present invention provides an ear tip, which solves the problem of the user feeling uncomfortable when having worn the earphone.

The present invention provides an ear tip including an inner-tube portion, an outer-flange portion and a bump portion. The inner-tube portion is configured to be mounted to an audio output tube of an insert-type earphone. The outer-flange portion is extended from a side of the inner-tube portion, surrounds the inner-tube portion and has a smooth outer surface. The bump portion is disposed on the smooth outer surface, so as to maintain an air-leaking channel at periphery of the bump portion when the ear tip is inserting into a canal of a user.

According to one embodiment of the present invention, the bump portion is in round diskshape.

According to one embodiment of the present invention, the bump portion includes at least one strip-shaped bump, extended from a side of the outer-flange portion away from the inner-tube portion along an axial direction of the inner-tube portion.

According to one embodiment of the present invention, the bump portion includes at least one rectangular-shaped bump, distributed over a region of the outer-flange portion close to the inner-tube portion. In addition, the bump portion further includes an annular-shaped bump, disposed at a side of the outer-flange portion away from the inner-tube portion and connecting the rectangular-shaped bump.

According to one embodiment of the present invention, the ear tip is integrally formed.

According to one embodiment of the present invention, the material of the ear tip is silicone.

Based on the above, in the ear tip of the present invention, there is great space at the periphery of the bump portion which may be an air-leaking channel, and the user does not need to worry about the air-leaking channel being jammed, which ensures the comfort of the user in using the earphone.

In order to make the aforementioned features of the disclosure more comprehensible, embodiments accompanied with figures are described in details below.

### BRIEF DESCRIPTION OF THE DRAWINGS

FIG. 1 is a schematic view of a conventional earphone inserted into a canal of a user.

FIG. 2A is a front view of an ear tip inserted into a canal of a user according to an embodiment of the present invention, and FIG. 2B is a cross-sectional view of the ear tip in FIG. 2A.

FIG. 3A is a front view of an ear tip according to another embodiment of the present invention, and FIG. 3B is a cross-sectional view of the ear tip in FIG. 3A.

FIG. 4A is a front view of an ear tip according to yet another embodiment of the present invention, and FIG. 4B is a cross-sectional view of the ear tip in FIG. 4A.

FIG. 5A is a front view of an ear tip according to still another embodiment of the present invention, and FIG. 5B and FIG. 5C are cross-sectional views of the ear tip in FIG. 5A along two different cross sections.

### DESCRIPTION OF EMBODIMENTS

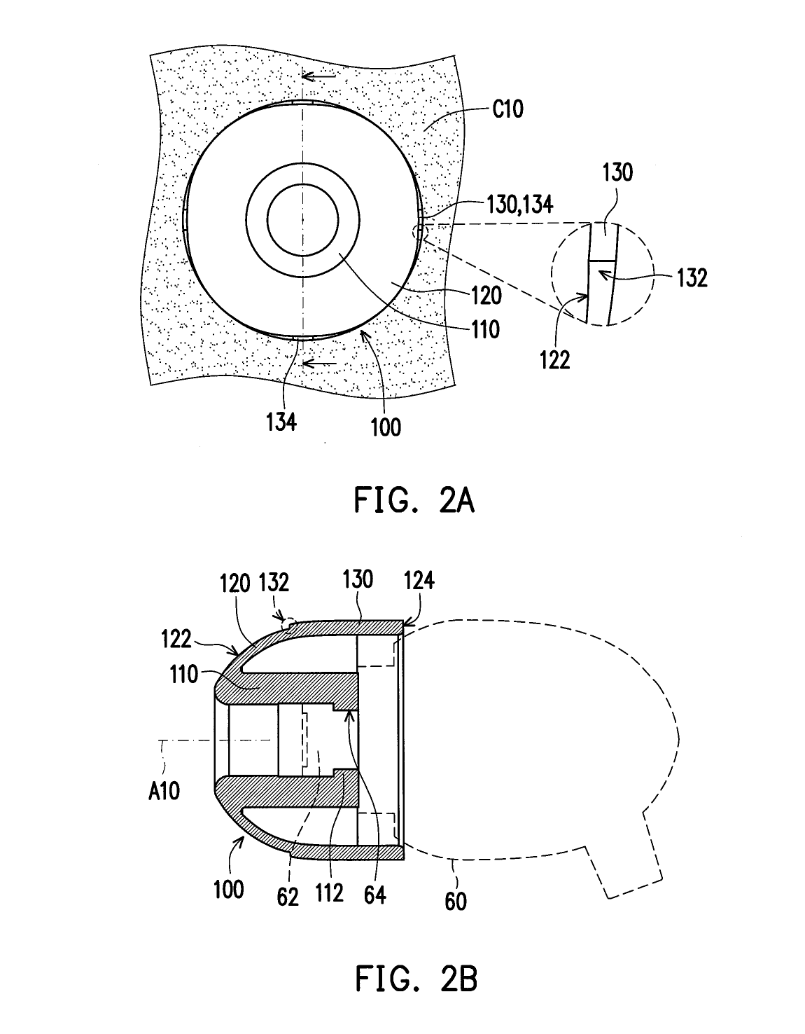

FIG. 2A is a front view of an ear tip inserted into a canal of a user according to an embodiment of the present invention, and FIG. 2B is a cross-sectional view of the ear tip in FIG. 2A. Referring to FIG. 2A and FIG. 2B, the ear tip 100 of the present embodiment includes an inner-tube portion 110, an outer-flange portion 120 and a bump portion 130. The inner-tube portion 110 is configured to be mounted to an audio output tube 62 of an insert-type earphone 60. The insert-type earphone 60 means a portion of the ear tip 100 of the insert-type earphone 60 is suitable for inserting into a canal C10 of a user, and it is different from the earmuff-type earphone which does not insert into the canal C10 of the user. The inner-tube portion 110 is generally in tube shape. The outer-flange portion 120 is extended from a side of the inner-tube portion 110 and surrounds the inner-tube portion 110. The outer-flange portion 120 has a smooth outer surface 122. In general, the appearance of the inner-tube portion 110 and the outer-flange portion 120 combined together is similar to a mushroom. The outer-flange portion 120 may be elastically deformed to adopt the shape of the canal C10 of the user due to the space between the inner-tube portion 110 and the outer-flange portion 120. The bump portion 130 is disposed on the smooth outer surface 122 of the outer-flange portion 120, so as to maintain an air-leaking channel 132 at periphery of the bump portion 130 when the ear tip 100 is inserting into the canal C10 of the user.

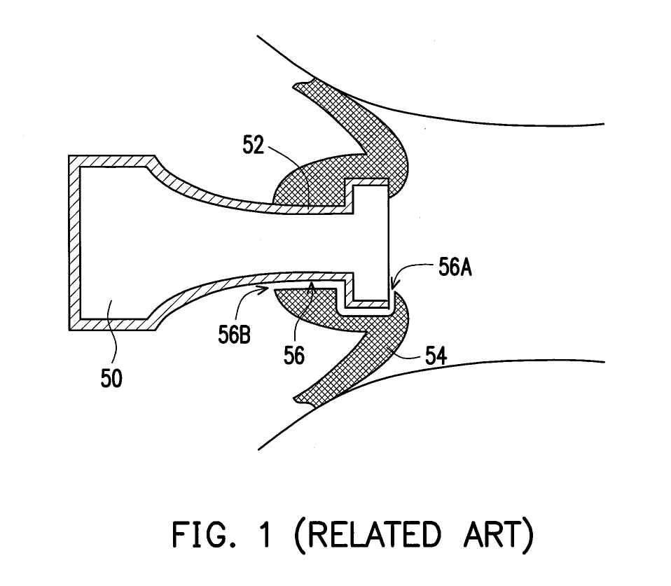

In other words, when the ear tip 100 is inserting into the canal C10 of the user, the outer-flange portion 120 is elastically deformed to adopt the shape of the canal C10 of the user so as to be fit with the canal C10. Meanwhile, the surface of the bump portion 130 also contacts with the canal C10. Because of a segmented step between the surface of the bump portion 130 and the smooth outer surface 122 of the outer-flange portion 120, the portion of the smooth outer surface 122 of the outer-flange portion 120 located at the periphery of the bump portion 130 does not contact with the canal, so as to maintain the air-leaking channel 132. Therefore, the air inside the canal C10 may leak out from the air-leaking channel 132 when the ear tip 100 is inserting into the canal C10 of the user, so as to avoid the discomfort caused by the air pressure pressing the eardrum of the user, and also keep the membrane of the speaker inside the insert-type earphone 60 from broken to maintain satisfactory sound quality. Moreover, the air-leaking channel 132 is a spacious region, so the air-leaking function of the air-leaking channel 132 would not be disabled due to earwax or other particles jammed at any small range of the region. That is to say, in the present embodiment, the air-leaking channel 132 is formed at the intersection of the bump portion 130 and the outer-flange portion 120 to solve the problem of the trench 56 in the conventional ear tip in FIG. 1 as an air-leaking path which is easily jammed by earwax or other particles.

The bump portion 130 of the present embodiment includes at least one strip-shaped bump 134, extended from a side 124 of the outer-flange portion 120 away from the inner-tube portion 110 along an axial direction A10 of the inner-tube portion 110. Four strip-shaped bumps 134 are illustrated in the present embodiment. In addition, for example, the inner diameter of the inner-tube portion 110 is slightly smaller than the outer diameter of the audio output tube 62, such that the inner-tube portion can be tightly mounted to the audio output tube 62 and does not fall off easily. Furthermore, the inner surface of the inner-tube portion 110 may have an engaged bump 112 for being engaged with a slot 64 of the audio output tube 62, so as to avoid the inner-tube portion 110 to fall off from the audio output tube 62. In the present embodiment, the ear tip 100 may be integrally formed, which means there is no bonding structure between the inner-tube portion 110, the outer-flange portion 120 and the bump portion 130, so there is no such problem as the yield of bonding not being satisfactory. In addition, for the ear tip 100 capable of elastically deformed to adopt different users' canals and providing comfort when being worn, the material of the ear tip 100 may be silicone or other suitable material.

Other embodiments are given for illustration below. It should be noted that the reference numerals and a part of the contents in the aforementioned embodiment are used in the following embodiments, in which identical reference numerals are adopted to represent identical or similar components, and repeated descriptions of the same technical contents are omitted. For detailed descriptions of the omitted parts, a reference can be found in the aforementioned embodiment, and repeated descriptions thereof are omitted in the following embodiments.

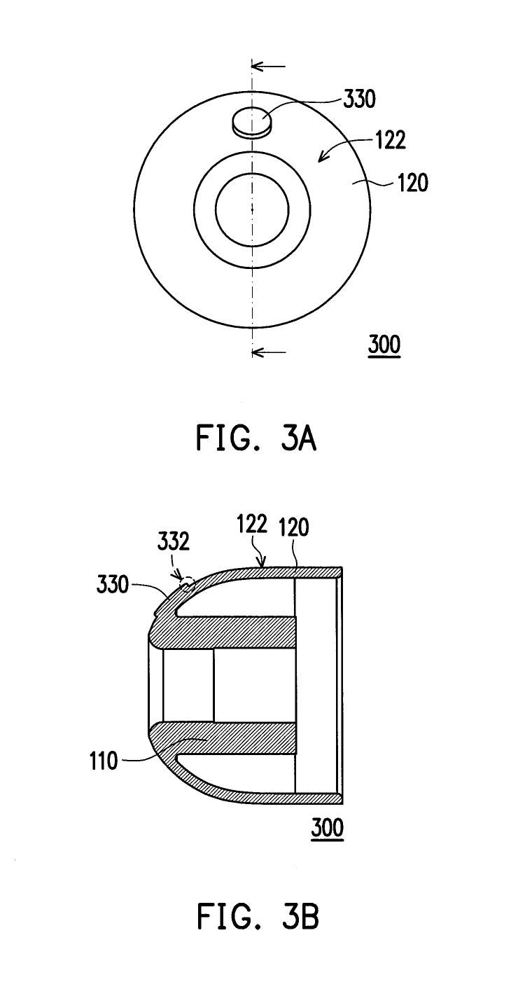

FIG. 3A is a front view of an ear tip according to another embodiment of the present invention, and FIG. 3B is a cross-sectional view of the ear tip in FIG. 3A. Referring to FIG. 3A and FIG. 3B, the ear tip 300 of the present embodiment is similar to the ear tip 100 in FIG. 2A, and the difference is that the bump portion 330 of the present embodiment is in round diskshape. Because of the segmented step between the surface of the bump portion 330 and the smooth outer surface 122 of the outer-flange portion 120, the portion of the smooth outer surface 122 of the outer-flange portion 120 located at the periphery of the bump portion 330 does not contact with the canal, so as to maintain the air-leaking channel 332. Therefore, the air inside the canal may leak out from the air-leaking channel 332 when the ear tip 300 is inserting into the canal of the user, so as to avoid the discomfort caused by the air pressure pressing the eardrum of the user, and also keep the membrane of the speaker inside the insert-type earphone from broken to maintain satisfactory sound quality.

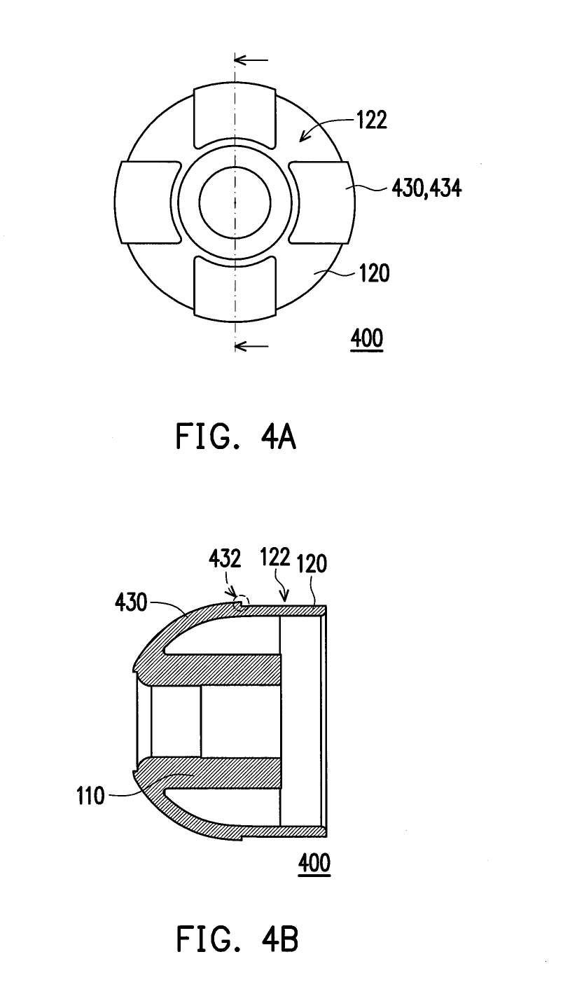

FIG. 4A is a front view of an ear tip according to yet another embodiment of the present invention, and FIG. 4B is a cross-sectional view of the ear tip in FIG. 4A. Referring to FIG. 4A and FIG. 4B, the ear tip 400 of the present embodiment is similar to the ear tip 100 in FIG. 2A, and the difference is that the bump portion 430 of the present embodiment includes at least one rectangular-shaped bump 434, distributed over the region of the outer-flange portion 120 close to the inner-tube portion 110. Four rectangular-shaped bumps 434 symmetrically arranged are illustrated in the present embodiment. Because of the segmented step between the surface of the bump portion 430 and the smooth outer surface 122 of the outer-flange portion 120, the portion of the smooth outer surface 122 of the outer-flange portion 120 located at the periphery of the bump portion 430 does not contact with the canal, so as to maintain the air-leaking channel 432. Therefore, the air inside the canal may leak out from the air-leaking channel 432 during the process of the ear tip 400 inserting into the canal of the user, so as to avoid the discomfort caused by the air pressure pressing the eardrum of the user, and also keep the membrane of the speaker inside the insert-type earphone from broken to maintain satisfactory sound quality.

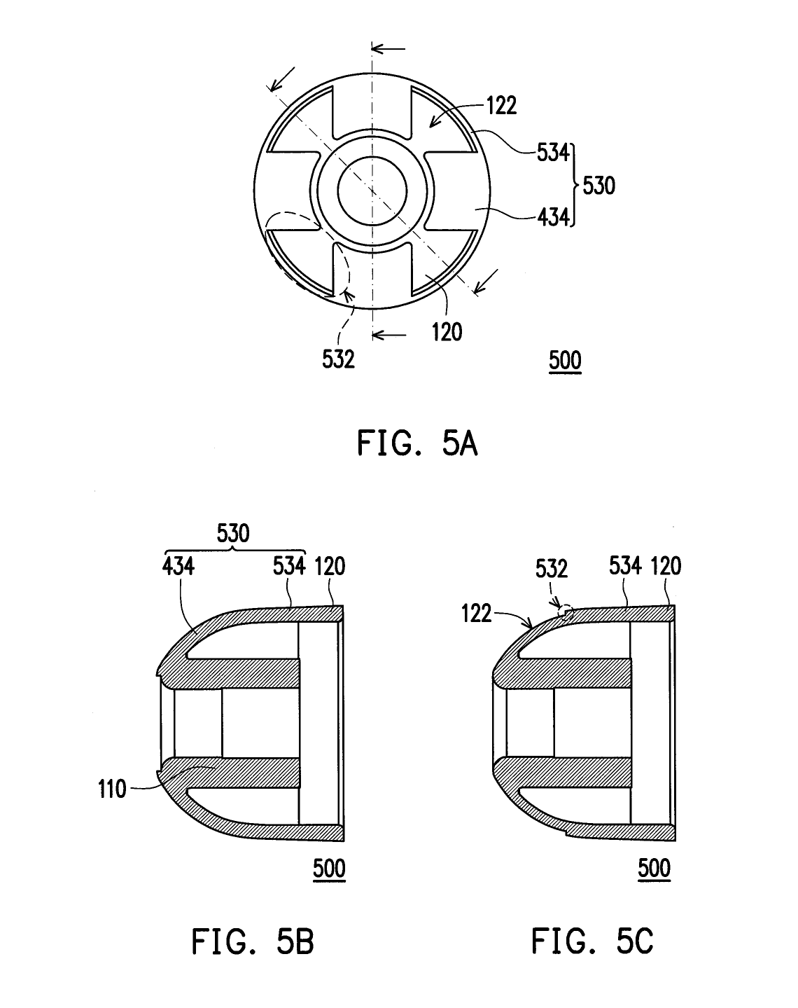

FIG. 5A is a front view of an ear tip according to still another embodiment of the present invention, and FIG. 5B and FIG. 5C are cross-sectional views of the ear tip in FIG. 5A along two different cross sections. Referring to FIG. 5A to FIG. 5C, the ear tip 500 of the present embodiment is similar to the ear tip 400 in FIG. 4A, and the difference is that the bump portion 530 of the present embodiment, apart from including the four rectangular-shaped bumps 434, further includes an annular-shaped bump 534 which is disposed on a side of the outer-flange portion 120 away from the inner-tube portion 110 and connects the four rectangular-shaped bumps 434. Because of the segmented step between the surface of the bump portion 530 and the smooth outer surface 122 of the outer-flange portion 120, the portion of the smooth outer surface 122 of the outer-flange portion 120 located at the periphery of the bump portion 530 does not contact with the canal, so as to maintain the air-leaking channel 532. Therefore, the air inside the canal may leak out from the air-leaking channel 532 during the process of the ear tip 500 inserting into the canal of the user, so as to avoid the discomfort caused by the air pressure pressing the eardrum of the user, and also keep the membrane of the speaker inside the insert-type earphone from broken to maintain satisfactory sound quality. Moreover, after the ear tip 500 is disposed in a proper position in the canal of the user, the annular-shaped bump 534 may be completely fit with the canal of the user to shield the external sound and improve the sound quality.

In sum, in the ear tip of the present invention, there is great space at the periphery of the bump portion which may be an air-leaking channel for leaking air when the ear tip is inserting into a canal of a user. Thus, a sense of pressure toward the eardrum of the user may be avoided, and broken the membrane of the earphone may also be avoided. Meanwhile, the air-leaking channel of the ear tip of the present invention has spacious space, which solves the problem in the prior art that the air-leaking channel is easily jammed by earwax or other particles and unable to leak out the air.

Although the disclosure has been disclosed by the above embodiments, they are not intended to limit the disclosure. It will be apparent to people of ordinary skill in the art that modifications and variations to the structure of the disclosed embodiments may be made without departing from the spirit and the scope of the disclosure. Accordingly, the protection scope of the disclosure falls in the appended claims.

What is claimed is:

1. An ear tip, comprising:
an inner-tube portion, configured to be mounted to an audio output tube of an insert-type earphone;
an outer-flange portion, extended from a side of the inner-tube portion and having a smooth outer surface; and
a bump portion, disposed on the smooth outer surface, so as to maintain an air-leaking channel at periphery of the bump portion during the process of the ear tip inserting into a canal of a user.

2. The ear tip as claimed in claim 1, wherein the bump portion is in round diskshape.

3. The ear tip as claimed in claim 1, wherein the bump portion comprises at least one strip-shaped bump, extended from a side of the outer-flange portion away from the inner-tube portion along an axial direction of the inner-tube portion.

4. The ear tip as claimed in claim 1, wherein the bump portion comprises at least one rectangular-shaped bump, distributed over a region of the outer-flange portion close to the inner-tube portion.

5. The ear tip as claimed in claim 4, wherein the bump portion comprises an annular-shaped bump, disposed at a side of the outer-flange portion away from the inner-tube portion and connecting the at least one rectangular-shaped bump.

6. The ear tip as claimed in claim 1 is integrally formed.

7. The ear tip as claimed in claim 6, wherein the material of the ear tip is silicone.
